(19) United States
(12) Patent Application Publication
(10) Pub. No.: US 2026/0145420 A1
(43) Pub. Date: May 28, 2026

(54) LIQUID JET HEAD AND LIQUID JET RECORDING APPARATUS

(71) Applicant: SII Printek Inc., Chiba-shi (JP)

(72) Inventor: Yasuhito SEKIYA, Chiba-shi (JP)

(21) Appl. No.: 19/394,472

(22) Filed: Nov. 19, 2025

(30) Foreign Application Priority Data
Nov. 28, 2024 (JP) 2024-207554

(51) Int. Cl. B41J 2/045

(52) U.S. Cl. CPC B41J 2/04541; B41J 2/04518; B41J 2/0455; B41J 2/04551; B41J 2/04573; B41J 2/04581; B41J 2/04588

(57) ABSTRACT

A liquid jet head and so on cost reduction of which can be achieved are provided. The liquid jet head according to an embodiment of the present disclosure includes a jet section including a plurality of nozzles, and a single drive board or a plurality of drive boards configured to output drive signals for jetting the liquid from the nozzles based on a differential signal supplied from a print control unit outside the liquid jet head. The drive board includes a single drive device or a plurality of drive devices configured to generate the drive signals based on the differential signal. The drive device includes a signal conversion unit configured to perform signal conversion processing on the differential signal to thereby generate a single-ended signal including print data and a data clock, and a signal generation unit configured to generate the drive signals base on the print data and the data clock, and to use the data clock as a first clock configured to define a unit period in drive waveforms of the drive signals.

### RELATED APPLICATIONS

This application claims priority to Japanese Patent application No. JP2024-207554, filed on Nov. 28, 2024, the entire content of which is incorporated herein by reference.

### BACKGROUND OF THE INVENTION

### 1. Field of the Invention

The present disclosure relates to a liquid jet head and a liquid jet recording apparatus.

### 2. Description of the Related Art

Liquid jet recording apparatuses equipped with liquid jet heads are used in a variety of fields, and a variety of types of liquid jet heads are developed.

In such a liquid jet head, in general, it is required to achieve a reduction in cost.

It is desirable to provide a liquid jet head and a liquid jet recording apparatus a cost reduction of which can be achieved.

### SUMMARY OF THE INVENTION

A liquid jet head according to an embodiment of the present disclosure includes a jet section including a plurality of nozzles, and a single drive board or a plurality of drive boards configured to output drive signals for jetting a liquid from the nozzles based on a differential signal supplied from a print control unit outside the liquid jet head. The drive board includes a single drive device or a plurality of drive devices configured to generate the drive signals based on the differential signal. The drive device includes a signal conversion unit configured to perform signal conversion processing on the differential signal to thereby generate a single-ended signal including print data and a data clock, and a signal generation unit configured to generate the drive signals base on the print data and the data clock, and to use the data clock as a first clock configured to define a unit period in drive waveforms of the drive signals.

A liquid jet recording apparatus according to an embodiment of the present disclosure includes the liquid jet head according to an embodiment of the present disclosure, and the print control unit.

According to the liquid jet head and the liquid jet recording apparatus related to an embodiment of the present disclosure, it becomes possible to achieve a reduction in cost.

### BRIEF DESCRIPTION OF THE DRAWINGS

FIG. 1 is a block diagram showing an outline configuration example of a liquid jet apparatus according to an embodiment of the present disclosure.

FIG. 2 is a block diagram showing a detailed configuration example of a liquid jet head shown in FIG. 1.

FIG. 3 is a block diagram showing a detailed configuration example of a drive device shown in FIG. 2.

FIG. 4 is a block diagram showing a configuration example of a liquid jet head related to a comparative example.

FIG. 5 is a block diagram showing a detailed configuration example of a drive device shown in FIG. 4.

### DETAILED DESCRIPTION OF THE PREFERRED EMBODIMENTS

An embodiment of the present disclosure will hereinafter be described in detail with reference to the drawings. It should be noted that the description will be presented in the following order.

1. Embodiment (An example in which a data clock obtained from a differential signal is applied to another clock)

2. Modified Examples

### 1. Embodiment

### Outline Configuration of Printer 5

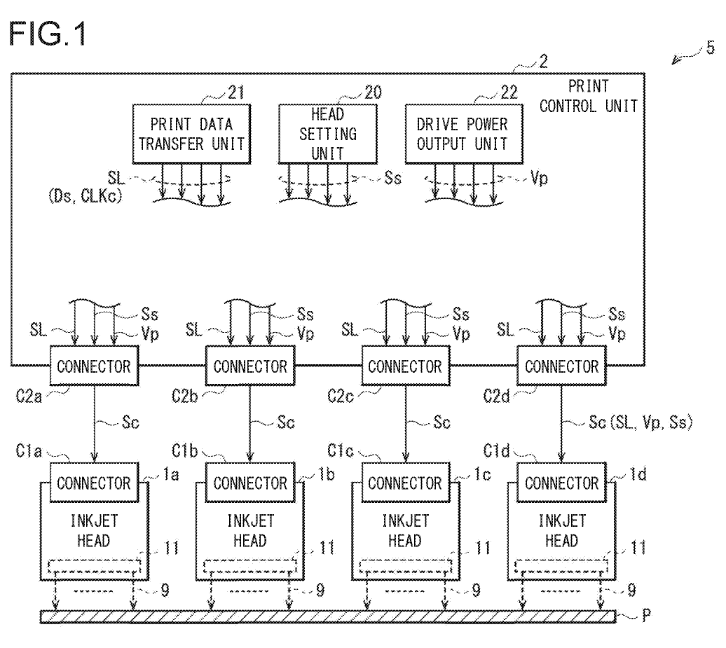

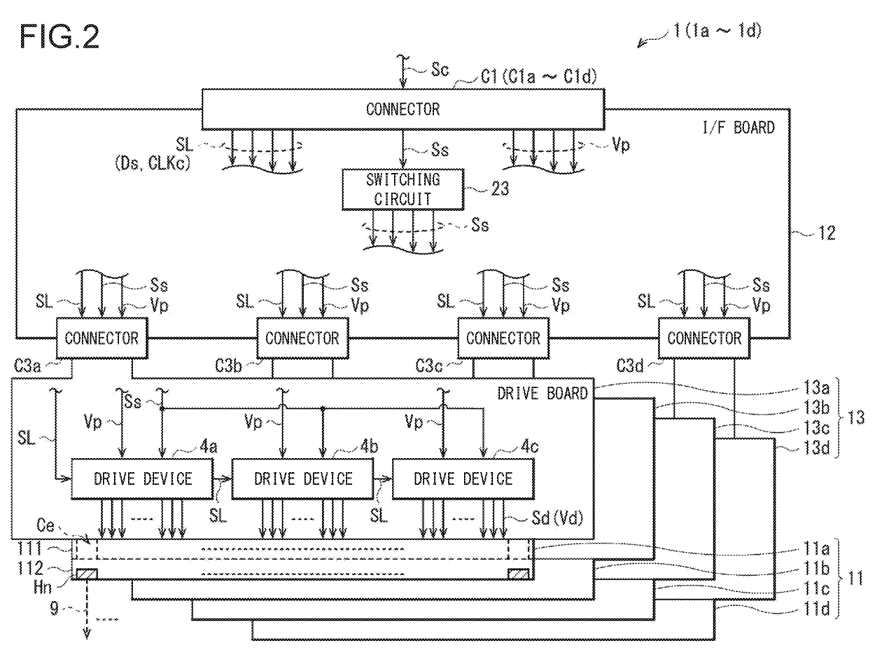

FIG. 1 is a block diagram showing an outline configuration example of a printer 5 as a liquid jet recording apparatus according to an embodiment of the present disclosure. FIG. 2 is a block diagram showing a detailed configuration example of inkjet heads 1 (1a, 1b, 1c, and 1d) as liquid jet heads shown in FIG. 1.

It should be noted that a scale size of each of the members is appropriately altered so that the member is shown in a recognizable size in the drawings used in the description of the present specification.

The printer 5 is an inkjet printer that performs recording (printing) of images, characters, and the like on a recording target medium (e.g., recording paper P shown in FIG. 1) using ink 9 described later. As shown in FIG. 1, the printer 5 is provided with a plurality of (four in this example) inkjet heads 1a, 1b, 1c, and 1d, and a print control unit 2. It should be noted that the inkjet heads 1a, 1b, 1c, and 1d are hereinafter collectively referred to as inkjet heads 1 as appropriate for the sake of convenience.

Here, the inkjet heads 1 (1a, 1b, 1c, and 1d) each correspond to a specific example of a “liquid jet head” in the present disclosure, and the printer 5 corresponds to a specific example of a “liquid jet recording apparatus” in the present disclosure. Further, the ink 9 corresponds to a specific example of a “liquid” in the present disclosure.

### A. Print Control Unit 2

The print control unit 2 is for supplying each of the inkjet heads 1a, 1b, 1c, and 1d with a variety of types of information (data). Specifically, as shown in FIG. 1, the print control unit 2 is arranged to supply each of elements (drive devices 4a, 4b, and 4c described later and so on) in each of the inkjet heads 1a, 1b, 1c, and 1d with a print control signal Sc.

As shown in FIG. 1, this print control unit 2 includes a head setting unit 20, a print data transfer unit 21, a drive power output unit 22, and a plurality of (four in this example) connectors C2a, C2b, C2c, and C2d.

The head setting unit 20 is for individually outputting, to each of the inkjet heads 1a, 1b, 1c, and 1d, a head setting signal Ss for performing a variety of types of setting (setting of drive waveforms, operation setting, and so on) in each of the inkjet heads 1a, 1b, 1c, and 1d. Specifically, as shown in FIG. 1, it is arranged that the head setting signal Ss is transferred from the head setting unit 20 to the inkjet head 1a via the connector C2a, and the head setting signal Ss is transferred from the head setting unit 20 to the inkjet head 1b via the connector C2b. Similarly, it is arranged that the head setting signal Ss is transferred from the head setting unit 20 to the inkjet head 1c via the connector C2c, and the head setting signal Ss is transferred from the head setting unit 20 to the inkjet head 1d via the connector C2d.

As shown in FIG. 1, the print data transfer unit 21 is for transferring a differential signal SL (a serial transfer signal) including serial data Ds and a transfer clock CLKc to each of the inkjet heads 1a, 1b, 1c, and 1d via the respective connectors C2a, C2b, C2c, and C2d. Specifically, in the example of the present embodiment, this differential signal SL is an LVDS (Low Voltage Differential Signaling) signal.

The drive power output unit 22 is for outputting a power supply voltage Vp (drive power) for operating each of the inkjet heads 1a, 1b, 1c, and 1d to each of the inkjet heads 1a, 1b, 1c, and 1d via each of the connectors C2a, C2b, C2c, and C2d, respectively.

Such head setting signal Ss, differential signal SL, and power supply voltage Vp are arranged to be transferred, as the print control signal Sc, from the print control unit 2 to each of the inkjet heads 1a, 1b, 1c, and 1d (see FIG. 1). It should be noted that on this occasion, the head setting signal Ss is arranged to be transferred from the print control unit 2 to each of the inkjet heads 1a, 1b, 1c, and 1d using, for example, low-speed I²C (Inter-Integrated Circuit) communication.

### B. Inkjet Head 1

The inkjet heads 1 (1a, 1b, 1c, and 1d) are each a head which jets the ink 9 shaped like a droplet from a jet section 11 (a plurality of nozzle holes Hn) described later to the recording paper P as indicated by dotted arrows in FIG. 1 to thereby perform recording of images, characters, and so on. This inkjet head 1 is provided with a plurality of (four in this example) jet sections 11 (11a, 11b, 11c, and 11d), a plurality of (four in this example) drive boards 13 (13a, 13b, 13c, and 13d), a plurality of (four in this example) connectors C3a, C3b, C3c, and C3d, and a single I/F (interface) board 12 as shown in, for example, FIG. 1 and FIG. 2.

It should be noted that the jet sections 11a, 11b, 11c, and 11d are hereinafter collectively referred to as jet sections 11 as appropriate for the sake of convenience. Similarly, the drive boards 13a, 13b, 13c, and 13d are hereinafter collectively referred to as drive boards 13 as appropriate for the sake of convenience.

### B-1. I/F Board 12

As shown in FIG. 2, the I/F board 12 is a board intervening between an outside (the print control unit 2) of the inkjet head 1 and the drive boards 13a, 13b, 13c, and 13d. This I/F board 12 is provided with a single connector C1 (one of connectors C1a, C1b, C1c, and C1d), four connectors C3a, C3b, C3c, and C3d, and a switching circuit 23.

As shown in FIG. 2, the connector C1 is a connector which inputs the print control signal Sc transferred from the print control unit 2. The connectors C3a, C3b, C3c, and C3d are connectors which electrically couple the I/F board 12 to the drive boards 13a, 13b, 13c, and 13d, respectively. The switching circuit 23 is a circuit which switches the head setting signal Ss to be supplied via the connector C1 between the drive boards 13 (13a, 13b, 13c, and 13d) and then outputs the head setting signal Ss accordingly.

Specifically, as shown in FIG. 2, it is arranged that the differential signal SL and the power supply voltage Vp which have been input via the connector C1 are each transferred individually to the drive boards 13a, 13b, 13c, and 13d respectively via the connectors C3a, C3b, C3c, and C3d. Meanwhile, it is arranged that the head setting signal Ss which has been input via the connector C1 is switched in the switching circuit 23 between the drive boards 13, and is then transferred to the drive boards 13a, 13b, 13c, and 13d from the connectors C3a, C3b, C3c, and C3d, respectively.

### B-2. Jet Section 11

As shown in FIG. 2, the jet sections 11 (11a, 11b, 11c, and 11d) are each a section which has the plurality of nozzle holes Hn, and which jets the ink 9 from these nozzle holes Hn. It is arranged that such jet of the ink 9 is performed in accordance with drive signals Sd (drive voltages Vd) supplied from the drive devices 4 (4a, 4b, and 4c) which are described later and are disposed on each of the drive boards 13a, 13b, 13c, and 13d (see FIG. 2).

As shown in FIG. 2, such a jet section 11 is configured including an actuator plate 111 and a nozzle plate 112.

### Nozzle Plate 112

The nozzle plate 112 is a plate formed of a film material such as polyimide, or a metal material, and has the plurality of nozzle holes Hn described above as shown in FIG. 2. These nozzle holes Hn are formed side by side at predetermined intervals, and each have, for example, a circular shape. It should be noted that such a nozzle hole Hn corresponds to a specific example of a “nozzle” in the present disclosure.

### Actuator Plate 111

The actuator plate 111 is a plate formed of a piezoelectric material such as PZT (lead zirconate titanate). The actuator plate 111 is provided with a plurality of channels (pressure chambers). These channels are each a part for applying pressure to the ink 9, and are arranged side by side so as to be parallel to each other at predetermined intervals. Each of the channels is partitioned by drive walls (not shown) formed of a piezoelectric body, and forms a groove part having a recessed shape in a cross-sectional view.

As such channels, there exist ejection channels Ce (see FIG. 2) for ejecting the ink 9, and dummy channels (non-ejection channels) which do not eject the ink 9. In other words, it is arranged that the ejection channels Ce are filled with the ink 9 on the one hand, but the dummy channels are not filled with the ink 9 on the other hand. It should be noted that it is arranged that filling of each of the ejection channels Ce with the ink 9 is performed via, for example, a flow channel (a common flow channel) commonly communicated with such ejection channels Ce. Further, it is arranged that each of the ejection channels Ce is individually communicated with the nozzle hole Hn in the nozzle plate 112 on the one hand, but each of the dummy channels is not communicated with the nozzle hole Hn on the other hand. These ejection channels Ce and the dummy channels are alternately arranged side by side along an arrangement direction of the nozzle holes Hn.

Further, on inner side surfaces opposed to each other in the drive walls described above, there are respectively disposed drive electrodes. As the drive electrodes, there exist common electrodes disposed on the inner side surfaces facing the ejection channels Ce, and active electrodes (individual electrodes) disposed on the inner side surfaces facing the dummy channels. These drive electrodes and the drive devices 4 (4a, 4b, and 4c) described later are electrically coupled to each other via wiring lines or the like. Thus, it is arranged that the drive voltages Vd (the drive signals Sd) described above are applied from the drive devices 4 (4a, 4b, and 4c) to the drive electrodes (see FIG. 2).

### B-3. Drive Board 13

The drive boards 13a, 13b, 13c, and 13d are boards which electrically couple the I/F board 12 to the jet sections 11a, 11b, 11c, and 11d, respectively, as shown in FIG. 2. It is arranged that each of the drive boards 13a, 13b, 13c, and 13d outputs the drive voltage Vd (the drive signal Sd) described above toward the jet section 11 (the actuator plate 111) based on the differential signal SL, the head setting signal Ss, and the power supply voltage Vp which are supplied from the print control unit 2 via the I/F board 12.

On each of such drive boards 13a, 13b, 13c, and 13d, there is mounted (see FIG. 2) the plurality of drive devices 4 (three drive devices 4a, 4b, and 4c in this example). Specifically, as shown in FIG. 2, each of the drive devices 4a, 4b, and 4c generates the drive voltage Vd (the drive signal Sd) described above based on the differential signal SL, the head setting signal Ss, and the power supply voltage Vp, and then outputs the drive voltage Vd (the drive signal Sd) toward the jet section 11 (the actuator plate 111). Further, in the example in FIG. 2, these drive devices 4a, 4b, and 4c are cascaded to each other via signal lines of the differential signal SL.

It should be noted that the drive devices 4a, 4b, and 4c are hereinafter collectively referred to as drive devices 4 as appropriate for the sake of convenience.

### Detailed Configuration of Drive Devices 4

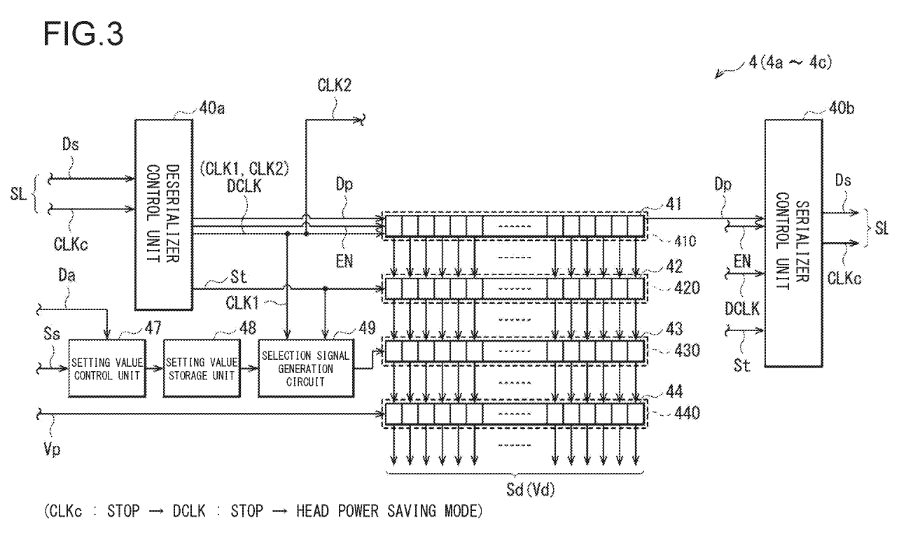

Then, a detailed configuration example of the drive devices 4 (4a, 4b, and 4c) described above will be described with reference to FIG. 3. FIG. 3 is a block diagram showing a detailed configuration example of each of the drive devices 4 (4a, 4b, and 4c).

The drive device 4 includes a deserializer control unit 40a, a serializer control unit 40b, a shift register unit 410, a latch circuit unit 420, a waveform selection circuit unit 430, a drive switch circuit unit 440, a setting value control unit 47, a setting value storage unit 48, and a selection signal generation circuit 49.

Here, the deserializer control unit 40a corresponds to a specific example of a “signal conversion unit” in the present disclosure. Further, the shift register unit 410, the latch circuit unit 420, the waveform selection circuit unit 430, the drive switch circuit unit 440, and the selection signal generation circuit 49 each correspond to a specific example of a “signal generation unit” in the present disclosure.

As shown in FIG. 3, the deserializer control unit 40a is a circuit which performs signal conversion processing on the differential signal SL including the serial data Ds and the transfer clock CLKc described above to thereby generate single-ended signals configured with parallel data. Specifically, it is arranged that the deserializer control unit 40a performs such signal conversion processing to thereby generate the single-ended signals (the parallel data) including the print data Dp, an enable signal EN representing a validity period of the print data Dp, a data clock DCLK, and an ejection timing signal St (see FIG. 3).

The serializer control unit 40b is a circuit which performs the signal conversion processing on the single-ended signals (the parallel data) including the print data Dp output from the shift register unit 410 (FF circuits 41) described later, and the enable signal EN, the data clock DCLK, and the ejection timing signal St described above. Specifically, as shown in FIG. 3, it is arranged that the serializer control unit 40b performs the signal conversion processing on such single-ended signals to thereby generate the differential signal SL including the serial data Ds and the transfer clock CLKc described above and then output the differential signal SL.

As shown in FIG. 3, the shift register unit 410 is a circuit for sequentially transmitting the print data Dp for the plurality of nozzle holes Hn from an anterior stage side toward a posterior stage in accordance with the drive signals Sd for the plurality of nozzle holes Hn, and then holding the result. The shift register unit 410 has the same number of (n in this example) FF (flip-flop) circuits 41 as the number of corresponding plurality of nozzle holes Hn. In each of the FF circuits 41, it is possible to hold, for example, 4-bit print data Dp in sync with the data clock DCLK in a period (the validity period of the print data DP) in which the enable signal EN supplied from the deserializer control unit 40a is active.

As shown in FIG. 3, the latch circuit unit 420 is a circuit for holding the print data Dp for the plurality of nozzle holes Hn output from the FF circuits 41 in the shift register unit 410 in sync with the ejection timing signal St described above. The latch circuit unit 420 has the same number of (n in this example) latch circuits 42 as the number of the corresponding plurality of nozzle holes Hn, and is made possible to hold, for example, 4-bit print data Dp (print data main body Dpb) in each of the latch circuits 42.

As shown in FIG. 3, the waveform selection circuit unit 430 is a circuit which generates switch control signals based on the print data Dp for the plurality of nozzle holes Hn output from the latch circuits 42 in the latch circuit unit 420, and a selection signal output from the selection signal generation circuit 49 described later. The waveform selection circuit unit 430 has the same number of (n in this example) waveform selection circuits 43 as the number of corresponding plurality of nozzle holes Hn, and is arranged to generate switch control signals for the plurality of nozzle holes Hn in the waveform selection circuits 43.

As shown in FIG. 3, the drive switch circuit unit 440 is a circuit which generates the drive signals Sd for the plurality of nozzles Hn based on the switch control signals for the plurality of nozzle holes Hn output from the waveform selection circuits 43 in the waveform selection circuit unit 430. The drive switch circuit unit 440 has the same number of (n in this example) drive switch circuits 44 as the number of corresponding plurality of nozzle holes Hn. Further, the drive switch circuits 44 are arranged to respectively generate drive signals Sd having the drive voltages Vd corresponding respectively to the n nozzle holes Hn by performing conversion of signal levels (voltage values) based on such switch control signals and the power supply voltage Vp described above (see FIG. 3).

As shown in FIG. 3, the setting value control unit 47 is a circuit which controls the head setting signal Ss input to each of the drive devices 4 in accordance with address data Da which defines a device address unique to each of the drive devices 4. The setting value storage unit 48 is a circuit which stores a setting value to be used in the selection signal generation circuit 49 in accordance with control by the setting value control unit 47.

The selection signal generation circuit 49 is a circuit which generates a selection signal to be used when generating the switch control signals in the waveform selection circuit unit 430 described above based on the setting value stored in the setting value control unit 47, the ejection timing signal St described above, and a predetermined first clock CLK1. This first clock CLK1 is a clock which defines a unit period in the drive waveforms of the drive signals Sd described above.

Here, as shown in FIG. 3, in the drive device 4 of the present embodiment, it is configured that the data clock DCLK which is obtained by the signal conversion processing on the differential signal SL (in the deserializer control unit 40a) is also used as the first clock CLK1 described above. This first clock CLK1 is a clock which defines the unit period in the drive waveforms of the drive signals Sd, and is arranged to be supplied to the selection signal generation circuit 49 described above (see FIG. 3). Further, as shown in FIG. 3, in the drive device 4, it is configured that the data clock DCLK described above is also used as a second clock CLK2 which is a system clock inside this drive device 4.

Further, as shown in FIG. 3, in the present embodiment, when the transfer clock CLKc contained in the differential signal SL is stopped by the print control unit 2, the following setting is performed. That is, in this case, it is arranged that by also stopping the data clock DCLK in the inkjet head 1, this inkjet head 1 is set to a power saving mode (a head power saving mode). When this head power saving mode is set, since the data clock DCLK is stopped, the operation of generating the drive signals Sd in the drive device 4 is also stopped as a result.

### Operations, and Functions and Advantages

### A. Basic Operation of Printer 5

In this printer 5, a recording operation (a printing operation) of images, characters, and so on to the recording target medium (the recording paper P and so on) is performed using such a jet operation of the ink 9 by the inkjet head 1 as described below. Specifically, in the inkjet head 1 according to the present embodiment, the jet operation of the ink 9 using a shear mode is performed in the following manner.

First, the drive devices 4 (the drive devices 4a-4c) on each of the drive boards 13a, 13b, 13c, and 13d each apply the drive voltage Vd (the drive signal Sd) to the drive electrodes (the common electrode and the active electrode) described above in the actuator plate 111 in corresponding one of the jet sections 11 (11a-11d). Specifically, each of the drive devices 4 applies the drive voltage Vd to the drive electrodes disposed on the pair of drive walls partitioning the ejection channel Ce described above. Thus, the pair of drive walls each deform so as to protrude toward the dummy channel adjacent to the ejection channel Ce.

On this occasion, it results in that the drive wall makes a flexion deformation to have a V shape centering on an intermediate position in the depth direction in the drive wall. Further, due to such a flexion deformation of the drive wall, the ejection channel deforms as if the ejection channel Ce bulges. As described above, due to the flexion deformation caused by a piezoelectric thickness-shear effect in the pair of drive walls, the volume of the ejection channel Ce increases. Further, by the volume of the ejection channel Ce increasing, the ink 9 is induced into the ejection channel Ce as a result.

Subsequently, the ink 9 induced into the ejection channel Ce in such a manner turns to a pressure wave to propagate to the inside of the ejection channel Ce. Then, the drive voltage Vd to be applied to the drive electrodes becomes 0 (zero) V at a timing at which the pressure wave has reached the nozzle hole Hn of the nozzle plate 112 (or a timing around that timing). Thus, the drive walls are restored from the state of the flexion deformation described above, and as a result, the volume of the ejection channel Ce having once increased is restored again.

In such a manner, the pressure in the ejection channel Ce increases in the process that the volume of the ejection channel Ce is restored, and thus, the ink 9 in the ejection channel Ce is pressurized. As a result, the ink 9 shaped like a droplet is ejected toward the outside (toward the recording paper P) through the nozzle hole Hn (see FIG. 1). The jet operation (the ejection operation) of the ink 9 in the inkjet head 1 is performed in such a manner, and as a result, the recording operation of images, characters, and so on to the recording paper P is performed.

### B. Use Configuration of Various Clocks

Then, a use configuration of the variety of clocks described above in the present embodiment will be described in detail in comparison with a comparative example.

### B-1. Comparative Example

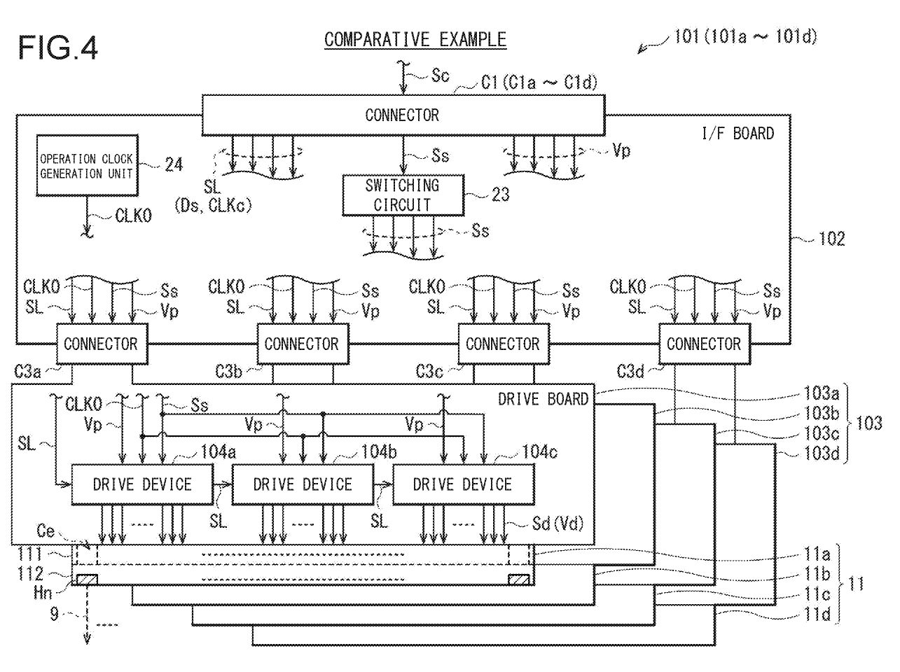

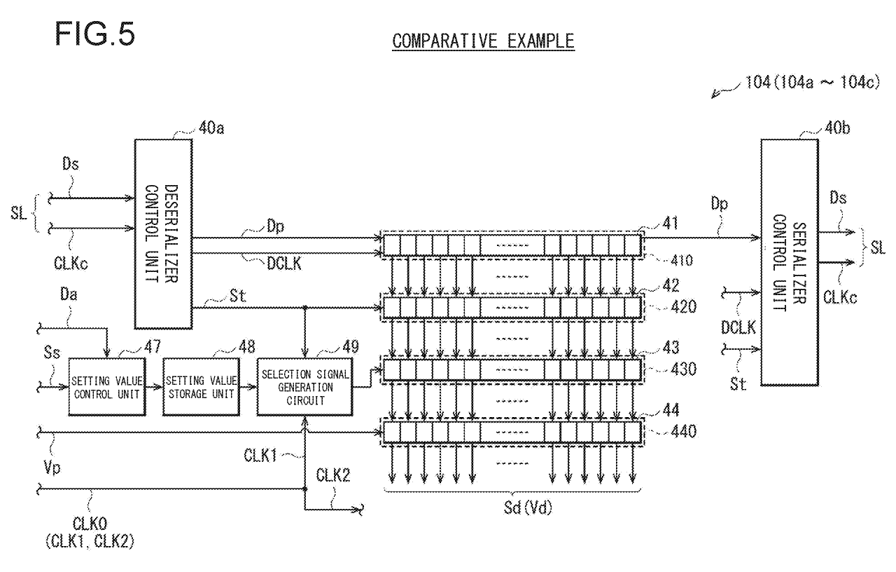

FIG. 4 is a block diagram showing a configuration example of inkjet heads 101 (101a-101d) according to the comparative example. Further, FIG. 5 is a block diagram showing a detailed configuration example of drive devices 104 (104a-104c) according to the comparative example shown in FIG. 4.

The inkjet heads 101 (101a-101d) of the comparative example shown in FIG. 4 are obtained by applying the following to the inkjet heads 1 (1a-1d) of the present embodiment shown in FIG. 2. That is, the inkjet head 101 according to the comparative example is obtained by providing an I/F board 102 instead of the I/F board 12, and at the same time, providing drive boards 103a-103d instead of the drive boards 13a-13d in the inkjet head 1 of the present embodiment. Further, each of the drive boards 103 (103a-103d) is provided with a plurality of drive devices 104 (104a-104c) related to the comparative example instead of the plurality of drive devices 4 (4a-4c) related to the present embodiment.

The I/F board 102 in the comparative example described above is obtained by further providing an operation clock generation unit 24 which generates an operation clock CLK0 in the I/F board 12 in the present embodiment. As shown in FIG. 4, it is arranged that the operation clock CLK0 generated in this operation clock generation unit 24 is supplied to each of the drive devices 104a-104c in each of the drive boards 103a-103d via corresponding one of the connectors C3a-C3d.

Further, the drive device 104 in the comparative example shown in FIG. 5 is basically provided with substantially the same configuration as that of the drive device 4 in the present embodiment shown in FIG. 3, but in this drive device 104, the use configuration of the various clocks is different from that in the drive device 4.

Specifically, as shown in FIG. 5, in the drive device 104 in this comparative example, the operation clock CLK0 to be used as the first clock CLK1 described above is separately supplied in addition to the differential signal SL which is a base of the data clock DCLK. That is, the operation clock CLK0 separately supplied is used as the first clock CLK1 which defines the unit period in the drive waveforms of the drive signals Sd. Further, as shown in FIG. 5, in the drive device 104, it is arranged that the operation clock CLK0 separately supplied is also used as the second clock CLK2 which is a system clock inside the drive device 104.

In this way, in the comparative example, a plurality of clocks (two types of clocks), that is, the data clock DCLK and the operation clock CLK0, are required as the clock sources in the drive device 104, which complicates the configuration. Further, since these two types of clocks are asynchronous with each other, and at the same time, a circuit (the operation clock generation unit 24) for generating the operation clock CLK0 and a buffer circuit of the operation clock CLK0, and so on are necessary in the inkjet head 101, the circuit configuration is complicated. Accordingly, in this comparative example, there is a concern that a cost in the inkjet head 101 may increase.

### B-2. Present Embodiment

In contrast, in the inkjet head 1 of the present embodiment, the following is achieved in the drive device 4 on the drive board 13. That is, as shown in FIG. 3, it is configured that the data clock DCLK obtained by the signal conversion processing on the differential signal SL supplied from the print control unit 2 is also used as the first clock CLK1 which defines the unit period in the drive waveforms of the drive signals Sd.

Thus, in the present embodiment, unlike the comparative example described above, just one clock source (the data clock DCLK) is only required in the drive device 4. Therefore, unlike the comparative example described above, in the present embodiment, the circuit (the operation clock generation unit 24) for generating the operation clock CLK0 and the buffer circuit for the operation clock CLK0, for example, become unnecessary, and the circuit configuration is simplified. As a result, in the present embodiment, it becomes possible to achieve the cost reduction in the inkjet head 1 compared to the comparative example described above.

Further, in the present embodiment, since it is arranged that data clock DCLK is also used as the second clock CLK2 which is the system clock in the drive device 4, the following is achieved. That is, since the circuit configuration is further simplified, it becomes possible to achieve further cost reduction in the inkjet head 1.

Further, in the present embodiment, since it is arranged that this inkjet head 1 is set to the power saving mode by stopping the transfer clock CLKc included in the differential signal SL to stop the data clock DCLK in the inkjet head 1, the following is achieved. That is, since it is possible to set the inkjet head 1 to the power saving mode using only the stoppage of such a transfer clock CLKc, it becomes possible to improve the convenience.

### 2. Modified Examples

The present disclosure is described hereinabove citing the embodiment, but the present disclosure is not limited to this embodiment, and a variety of modifications can be adopted.

For example, in the embodiment described above, the description is presented specifically citing the configuration examples (the shapes, the arrangements, the number, and so on) of each of the members in the printer and the inkjet head, but those described in the above embodiment are not limitations, and it is possible to adopt other shapes, arrangements, numbers and so on. Specifically, in the embodiment described above, for example, there is described the example when the plurality of inkjet heads is disposed in the printer, but this example is not a limitation, and it is possible to arrange that, for example, just one inkjet head is disposed alone in the printer.

Further, in the embodiment described above, the description is presented specifically citing the configuration examples of the I/F board (a relay board), the drive boards, the drive devices, and so on, but these configuration examples are not limited to those described in the above embodiment. Specifically, in the embodiment described above, for example, there is described the example when the plurality of drive boards is disposed in the inkjet head, but this example is not a limitation, and it is possible to arrange that, for example, just one drive board is disposed alone in the inkjet head. Further, in the embodiment described above, there is described the example when the I/F board is disposed in the inkjet head, but this example is not a limitation, and it is possible to arrange that, for example, the I/F board is not disposed in the inkjet head. Further, in the embodiment described above, there is described the example when the plurality of drive devices is disposed on the drive board, but this example is not a limitation, and it is possible to arrange that, for example, just one drive device is disposed alone on the drive board. In addition, the example when such a plurality of drive devices is cascaded to each other is described in the embodiment described above, but this is not a limitation, and it is possible to arrange that the plurality of drive devices is not cascaded to each other.

Further, in the embodiment described above, the description is presented specifically citing the use configuration of the various clocks, but the method described in the embodiment described above is not a limitation, and it is also possible to arrange to use the variety of clocks using, for example, other methods. In addition, the method of setting the inkjet head to the power saving mode by stopping the transfer clock contained in the differential signal is described in the embodiment described above, but it is possible to arrange, for example, not to use such a method of setting the power saving mode.

Further, the variety of numerical examples described in the embodiment described above are not limited to the numerical examples described in the embodiment, and can also be other numerical values.

Further, a variety of types of structures can be adopted as the structure of the inkjet head. Specifically, for example, it is possible to adopt a so-called side-shoot type inkjet head which emits the ink 9 from a central portion in the extending direction of each of the ejection channels Ce in the actuator plate 111. Alternatively, it is possible to adopt, for example, a so-called edge-shoot type inkjet head for ejecting the ink 9 along the extending direction of each of the ejection channels Ce. Further, the type of the printer is not limited to the type described in the above embodiment, and it is possible to apply a variety of types such as an MEMS (Micro Electro-Mechanical Systems) type.

Further, for example, it is possible to apply the present disclosure to either of an inkjet head of a circulation type which uses the ink 9 while circulating the ink 9 between the ink tank and the inkjet head, and an inkjet head of a non-circulation type which uses the ink 9 without being circulated.

Further, the series of processes described in the above embodiment can be arranged to be performed by hardware (a circuit), or can also be arranged to be performed by software (a program). When it is arranged that the series of processing is performed by the software, the software is constituted by a program group for making the computer perform the functions. The programs can be incorporated in advance in the computer described above to be used by the computer, for example, or can also be installed in the computer described above from a network or a recording medium to be used by the computer.

Further, in the above embodiment, the description is presented citing the printer (the inkjet printer) as a specific example of the “liquid jet recording apparatus” in the present disclosure, but this example is not a limitation, and it is also possible to apply the present disclosure to other apparatuses than the inkjet printer. In other words, it is also possible to arrange that the “liquid jet head” (the inkjet head) of the present disclosure is applied to other apparatuses than the inkjet printer. Specifically, it is also possible to arrange that the “liquid jet head” of the present disclosure is applied to an apparatus such as a facsimile or an on-demand printer.

In addition, it is also possible to apply the variety of examples described hereinabove in any combination.

It should be noted that the advantages described in the present specification are illustrative only, but are not a limitation, and other advantages can also be provided.

Further, the present disclosure can also take the following configurations.

(1) A liquid jet head configured to jet a liquid, and including

a jet section including a plurality of nozzles, and

a single drive board or a plurality of drive boards configured to output drive signals for jetting the liquid from the nozzles based on a differential signal supplied from a print control unit outside the liquid jet head, wherein

the drive board includes a single drive device or a plurality of drive devices configured to generate the drive signals based on the differential signal, and

the drive device includes

a signal conversion unit configured to perform signal conversion processing on the differential signal to thereby generate a single-ended signal including print data and a data clock, and

a signal generation unit configured to generate the drive signals base on the print data and the data clock, and to use the data clock as a first clock configured to define a unit period in drive waveforms of the drive signals.

(2) The liquid jet head according to (1) described above, wherein

the drive device uses the data clock as a second clock which is a system clock inside the drive device.

(3) The liquid jet head according to (1) or (2) described above, wherein

the plurality of drive devices is disposed on the drive board, and

the plurality of drive devices is cascaded to each other via a signal line of the differential signal.

(4) A liquid jet recording apparatus including

the liquid jet head according to any one of (1) to (3) described above or a plurality of liquid jet heads each identical to the liquid jet head, and

the print control unit.

(5) The liquid jet recording apparatus according to (4) described above, wherein

the print control unit sets the liquid jet head to a power saving mode by stopping a transfer clock contained in the differential signal to also stop the data clock in the liquid jet head.

What is claimed is:

1. A liquid jet head configured to jet a liquid comprising:
a jet section including a plurality of nozzles; and
a single drive board or a plurality of drive boards configured to output drive signals for jetting the liquid from the nozzles based on a differential signal supplied from a print control unit outside the liquid jet head, wherein
the drive board includes a single drive device or a plurality of drive devices configured to generate the drive signals based on the differential signal, and
the drive device includes
a signal conversion unit configured to perform signal conversion processing on the differential signal to thereby generate a single-ended signal including print data and a data clock, and
a signal generation unit configured to generate the drive signals base on the print data and the data clock, and to use the data clock as a first clock configured to define a unit period in drive waveforms of the drive signals.

2. The liquid jet head according to claim 1, wherein
the drive device uses the data clock as a second clock which is a system clock inside the drive device.

3. The liquid jet head according to claim 1, wherein
the plurality of drive devices is disposed on the drive board, and
the plurality of drive devices is cascaded to each other via a signal line of the differential signal.

4. A liquid jet recording apparatus comprising:
at least one of the liquid jet head according to claim 1; and
the print control unit.

5. The liquid jet recording apparatus according to claim 4, wherein
the print control unit sets the liquid jet head to a power saving mode by stopping a transfer clock contained in the differential signal to also stop the data clock in the liquid jet head.
